(19) United States
(12) Patent Application Publication
(10) Pub. No.: US 2026/0332855 A1
(43) Pub. Date: Oct. 22, 2026

(54) METHOD AND DEVICE FOR CONTROLLING VIDEO PLAYER ACCORDING TO MOTION CONTROL MODE IN CONTENT STREAMING SYSTEM

(71) Applicant: TVING CO., LTD., Seoul (KR)

(72) Inventor: Jun Hee KANG, Seoul (KR)

(21) Appl. No.: 19/110,408

(22) PCT Filed: Sep. 4, 2023
(86) PCT No.: PCT/KR2023/013168

§ 371 Date: Mar. 10, 2025

(30) Foreign Application Priority Data
Sep. 16, 2022 (KR) 10-2022-0116898

(51) Int. Cl. H04N 21/472; G06F 3/0346; G06F 3/0488; H04N 21/414; H04N 21/485

(52) U.S. Cl. CPC H04N 21/47217; G06F 3/0346; G06F 3/0488; H04N 21/41407; H04N 21/4852; H04N 21/4854

(57) ABSTRACT

Disclosed herein is a method and device for controlling a video player according to a motion control mode in a content streaming system. A method of controlling a video player including a processor and a memory according to a motion control mode comprises detecting at least one of a tilt detection signal or an impact detection signal of a device, determining a function of the video player in response to the detected signal, and controlling the video player in response to the determined function of the video player. The function of the video player may comprise at least one of a volume control function, a brightness control function, a playback/pause function or a fast forward/rewind function.

### DESCRIPTION

### Technical Field

The present disclosure relates to a content streaming system, and more particularly, to a method and device for controlling a video player according to a motion control mode in a content streaming system.

### Background Art

With the development of various technologies and changes in consumption trends, a great change has occurred in the way content is supplied and consumed. The development of digital technology, computer technology, Internet/communication technology, etc. has blurred the boundaries of the type of content and the subject of production, which has caused a great change in the creation and consumption patterns of content. Platforms have emerged that allow ordinary people to create and distribute content. In addition, ease of access to various contents has been secured, and various options for consumption methods have begun to be provided.

Among these many changes in the content industry, OTT (over the top) services exist. OTT service is a media platform based on Internet and mobile communication, and provides various contents to consumers without equipment such as a separate set-top box beyond existing broadcasting services. The concept of OTT service started by providing movies and television programs in the form of video on demand (VOD), but the OTT service is still expanding, by not only providing content created by OTT service providers but also expanding its scope to mobile platforms.

### DISCLOSURE OF INVENTION

### Technical Problem

An object of the present disclosure is to provide a method and method for controlling a video player according to a motion control mode.

Another object of the present disclosure is to provide a method and method for more easily operating a video player.

Another object of the present disclosure is to provide a method and method for controlling a function of a video player using a motion control mode.

The technical problems solved by the present disclosure are not limited to the above technical problems and other technical problems which are not described herein will be clearly understood by a person having ordinary skill in the technical field, to which the present disclosure belongs, from the following description.

### Solution to Problem

A method of controlling a video player according to a motion control mode according to an embodiment of the present disclosure may comprise detecting at least one of a tilt detection signal or an impact detection signal of a device, determining a function of the video player in response to the detected signal, and controlling the video player in response to the determined function of the video player. The function of the video player may comprise at least one of a volume control function, a brightness control function, a playback/pause function or a fast forward/rewind function.

According to an embodiment of the present disclosure, the method may further comprise detecting a mode switch request of a user and switching an operation mode of the video player to the motion control mode in response to the mode switch request of the user.

According to an embodiment of the present disclosure, the mode switch request of the user may correspond to at least one of touch input, device shaking operation or time setting of the user.

According to an embodiment of the present disclosure, the touch input of the user may be touch input for a certain period of time or longer to a rewind item or a fast forward item among video manipulation items included in a user interface of the video player.

According to an embodiment of the present disclosure, the tilt detection signal may comprise at least one of a right rotation signal, a left rotation signal, a right tilt signal, a left tilt signal, a lower rotation signal or an upper rotation signal of the device.

According to an embodiment of the present disclosure, the function of the video player corresponding to at least one of the tilt detection signal or the impact detection signal may be set by a user.

According to an embodiment of the present disclosure, the method may comprise receiving state information of a user and switching an operation mode of the video player to the motion control mode in response to the state information of the user.

According to an embodiment of the present disclosure, the state information of the user may comprise information on at least one of a location of the user, a motion state of the user or a means of movement of the user.

According to an embodiment of the present disclosure, the information on the location of the user may be determined by an identifier of an access point of a wireless network or a global positioning system (GPS) signal.

According to an embodiment of the present disclosure, the information on the motion state of the user or the means of movement of the user may be detected by at least one of a gyroscope, an acceleration sensor or a GPS sensor inside the device.

According to an embodiment of the present disclosure, the method may comprise recognizing occurrence of a readjustment situation of function control, checking control actually performed by the device and control intended by a user and updating a mapping relationship between a motion signal and function control.

A device for controlling a video player according to a motion control mode according to an embodiment of the present disclosure may comprise a memory configured to store information necessary for operation of the device and a processor connected to the memory. The processor may detect at least one of a tilt detection signal or an impact detection signal of the device, determine a function of the video player in response to the detected signal and control the video player in response to the determined function of the video player. The function of the video player may comprise at least one of a volume control function, a brightness control function, a playback/pause function or a fast forward/rewind function.

The features briefly summarized above with respect to the disclosure are merely exemplary aspects of the detailed description of the disclosure that follows, and do not limit the scope of the disclosure.

### Advantageous Effects of Invention

According to the present disclosure, it is possible to more conveniently manipulate a video player when it is inconvenient to use two hands.

According to the present disclosure, it is possible to conveniently control a function of a video player using motion.

It will be appreciated by persons skilled in the art that the effects that can be achieved through the present disclosure are not limited to what has been particularly described hereinabove and other advantages of the present disclosure will be more clearly understood from the detailed description.

### BRIEF DESCRIPTION OF DRAWINGS

FIG. 1 is a diagram illustrating a content streaming system according to an embodiment of the present disclosure.

FIG. 2 is a diagram illustrating a structure of a client device according to an embodiment of the present disclosure.

FIG. 3 is a diagram illustrating the concept of a content streaming service according to an embodiment of the present disclosure.

FIG. 4 is a flowchart illustrating a manipulation method using a motion control mode according to an embodiment of the present disclosure.

FIG. 5 is a diagram illustrating a function of a video player corresponding to a motion operation according to an embodiment of the present disclosure.

FIG. 6 is a flowchart illustrating a method of switching to a motion control mode according to an embodiment of the present disclosure.

FIG. 7 is a diagram of an embodiment of switching to a motion control mode corresponding to a user touch according to an embodiment of the present disclosure.

FIG. 8 is a diagram of an embodiment of switching to a motion control mode corresponding to user's shaking operation of a device according to an embodiment of the present disclosure.

FIG. 9 is a diagram illustrating an embodiment of switching to a motion control mode corresponding to time setting.

FIG. 10 is a diagram illustrating an embodiment of switching to a motion control mode corresponding to tilting of a device.

FIG. 11 is a flowchart illustrating a method of switching to a motion control mode according to an embodiment of the present disclosure.

FIG. 12 is a diagram illustrating an embodiment of switching to a motion control mode using a GPS according to an embodiment of the present disclosure.

FIG. 13 is a diagram illustrating an embodiment of switching to a motion control mode corresponding to wireless fidelity (WIFI) access point (AP) of a user according to an embodiment of the present disclosure.

FIG. 14 is a flowchart illustrating switching to a motion control mode corresponding to a location of a user according to an embodiment of the present disclosure.

FIG. 15 is a diagram illustrating an embodiment of switching to a motion control mode corresponding to an motion state of a user according to an embodiment of the present disclosure.

FIG. 16 is a diagram illustrating an embodiment of switching to a motion control mode corresponding to a means of movement of a user according to an embodiment of the present disclosure.

FIG. 17 is a diagram illustrating an embodiment of switching to a one-handed button mode according to an embodiment of the present disclosure.

FIG. 18 is a diagram illustrating a mode switching selection message according to an embodiment of the present disclosure.

FIG. 19 is a flowchart illustrating a function mapping method of a video player corresponding to a motion signal according to an embodiment of the present disclosure.

FIG. 20 is a flowchart illustrating a function control readjustment method according to an embodiment of the present disclosure.

### MODE FOR THE INVENTION

Hereinafter, embodiments of the present disclosure will be described in detail with reference to the accompanying drawings so that those skilled in the art can easily carry out the present disclosure. However, the present disclosure may be embodied in many different forms and is not limited to the embodiments set forth herein.

In describing the embodiments of the present disclosure, a detailed description of known configurations or functions will be omitted when it may obscure the subject matter of the present disclosure. In the drawings, parts not related to the description of the present disclosure are omitted, and similar reference numerals denote similar parts.

The functional blocks shown in the drawings and described below are only examples of possible implementations. Other functional blocks may be used in other implementations without departing from the spirit and scope of the detailed description. Additionally, although one or more functional blocks of the present disclosure are represented as separate blocks, one or more of the functional blocks of the present disclosure may be a combination of various hardware and software configurations that perform the same function.

In addition, the expression of including certain components is an expression of “open type” and simply indicates that the corresponding components are present, and should not be understood as excluding additional components. Furthermore, when a component is referred to as being “connected” or “coupled” to another component, it should be understood that it may be directly connected or coupled to the other component or intervening components may also be present.

In addition, a singular expression for an object may be understood as a plural expression, unless the context clearly indicates otherwise. In the present disclosure, expressions such as “A or B” or “at least one of A and/or B” may be understood to include all possible combinations of the items listed together. Expressions such as “first”, “second”, and “third” may modify the object regardless of order or importance, and are used only to distinguish one object from other objects of the same kind.

In addition, in the present disclosure, “configured to” may be understood as having the meaning technically equivalent to any one of expressions of “suitable for”, “having the ability to”, “changed to”, “made to”, “capable of” and “designed to” in terms of hardware or software, depending on the situation, and may be replaced with each other.

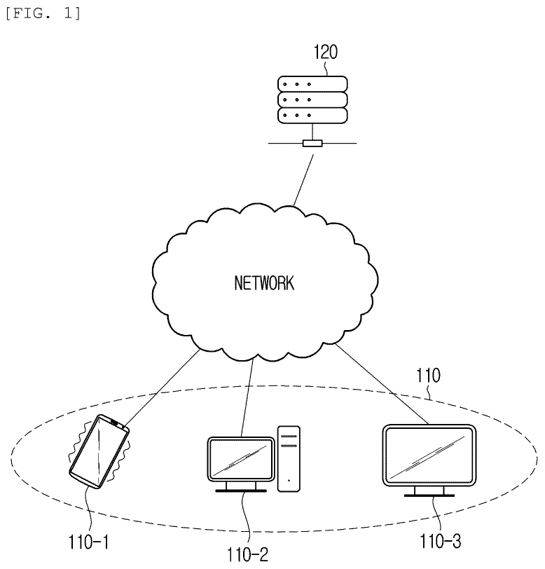

The present disclosure is to provide a method and device for controlling a video player according to a motion control mode in a content streaming system. Specifically, a method of manipulating a player with one hand by switching an operation mode of the video player to a motion control mode when the use of two hands is inconvenient will be described. In particular, the present disclosure presents various embodiments with respect to device manipulation for motion control and mode switching to a motion control mode. Here, the term video player may mean a module that performs a function of playing a video. FIG. 1 illustrates a content streaming system according to an embodiment of the present disclosure. FIG. 1 illustrates a system for providing services related to content, such as content streaming and content-related information provision, and entities belonging to the system. Hereinafter, in the present disclosure, various services related to content may be referred to as ‘content service’ or other terms having equivalent technical meaning.

Referring to FIG. 1, the content streaming system may include a client device 110 and a server 120. Here, the client device 110 is illustrated as a set of three client devices 110-1 to 110-3, but the content streaming system may include two or less or four or more client devices. In addition, although one server 120 is illustrated, the content streaming system may include a plurality of servers that share various functions and interact with each other.

The client device 110 receives and displays content. The client device 110 may receive content streamed from the server 120 after accessing the server 120 through a network. That is, the client device 110 is hardware on which client software or applications designed to use the content service provided by the server 120 are installed, and may interact with the server 120 through the installed software or applications. The client device 110 may be implemented as various types of devices. For example, the client device 110 may be one of a movable portable device, a device that is movable but generally fixed during use, and a device that is fixedly installed at a specific location.

Specifically, the client device 110 may be implemented in the form of at least one of a smartphone 110-1, a desktop computer 110-2, a tablet PC, a laptop PC, a netbook computer, a workstation, a server, a personal data assistant (PDA), a portable multimedia player (PMP), a camera, or a wearable device. Here, the wearable device may be implemented in the form of at least one of an accessory type (e.g., watch, ring, bracelet, anklet, necklace, glasses, contact lens, HMD (head-mounted-device)), clothing type, body attachment type (e.g., skin pad or tattoo), or bio implantable circuit. In addition, the client device 110 is a home appliance, and may be, for example, implemented in the form of at least one of a television 110-3, a digital video disk (DVD) player, an audio system, a refrigerator, an air conditioner, a vacuum cleaner, an oven, a microwave oven, a washing machine, or an air purifier.

The server 120 performs various functions to provide content services. In other words, the server 120 may provide services related to content streaming and various contents to the client device 110 using various functions. Specifically, the server 120 may perform datafication to stream content, and transmit the content to the client device 110 through a network. To this end, the server 120 may perform at least one of content encoding, data segmentation, transmission scheduling, or streaming transmission. Additionally, for the convenience of content use, the server 120 may further perform at least one function of providing a content guide, managing a user's account, analyzing a user preference, or recommending content based on preference. A plurality of functions among the various functions described above may be provided, and for this purpose, the server 120 may be implemented as a plurality of servers.

The client device 110 and the server 120 exchange information through a network, and a content service may be provided to the client device 110 based on the exchanged information. In this case, the network may be a single network or a combination of various types of networks. The network may be understood as a form in which different types of networks are connected according to regions. For example, the networks may include at least one of a wireless network or a wired network. Specifically, the networks include a cellular network based on at least one of 6^{th} generation (6G), 5^{th} generation (5G), long term evolution (LTE), LTE Advance (LTE-A), code division multiple access (CDMA), wideband CDMA (WCDMA), and universal mobile telecommunications system (UMTS), wireless broadband (WiMAX), or Global System for Mobile Communications (GSM). Also, the networks may include a local area network based on at least one of a wireless local area network (WLAN), Bluetooth, Zigbee, near field communication (NFC), or ultra wideband (UWB). In addition, the networks may include wired networks such as the Internet and Ethernet.

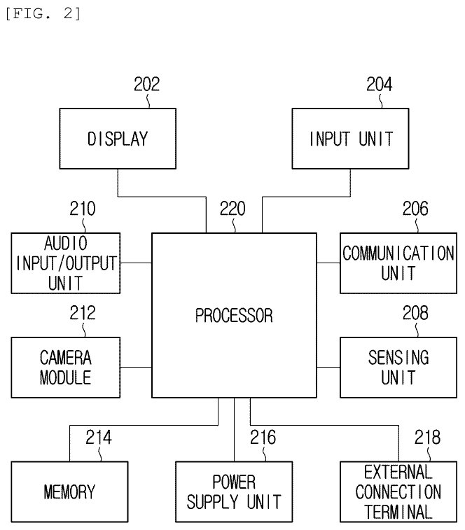

FIG. 2 illustrates a structure of a client device according to an embodiment of the present disclosure. FIG. 2 illustrates a block structure of a client device (e.g., the client device 110 of FIG. 1).

Referring to FIG. 2, the client device includes a display 202, an input unit 204, a communication unit 206, a sensing unit 208, an audio input/output unit 210, a camera module 212, a memory 214, a power supply unit 216, an external connection terminal 218 and a processor 220. However, depending on the type of device, at least one of the components illustrated in FIG. 2 may be omitted.

The display 202 outputs information such as visually recognizable images and graphics. To this end, the display 202 may include a panel and a circuit for controlling the panel. For example, the panel may include at least one of a liquid crystal display (LCD), a light emitting diode (LED), a light emitting polymer display (LPD), an organic light emitting diode (OLED), an active matrix organic light emitting diode (AMOLED) or a flexible LED (FLED).

The input unit 204 receives input generated by a user. The input unit 204 may include various types of input sensing units. For example, the input unit 204 may include at least one of a physical button, a keypad or a touch pad. Alternatively, the input unit 204 may include a touch panel. When the input unit 204 includes a touch panel, the input unit 204 and the display 202 may be implemented as one module.

The communication unit 206 provides an interface for enabling a client device to form a network with other devices and to transmit or receive data through the network. To this end, the communication unit 206 may include a circuit for physically processing signals (e.g., an encoder/decoder, a modulator/demodulator, a radio frequency (RF) front end, etc.), a protocol stack for processing data according to communication standards (e.g., modem), etc. According to various embodiments, the communication unit 206 may include a plurality of modules to support a plurality of different communication standards.

The sensing unit 208 collects sensing data including data on the state of the client device or the surrounding environment. For example, the sensing unit 208 may measure a physical value or a change in value related to an operating state or posture of the client device, and generate an electrical signal representing the measured result. In addition, the sensing unit 208 may measure a physical value or a change in value of the surrounding environment of the client device and generate an electrical signal representing the measured result. To this end, the sensing unit 208 may include at least one sensor and a circuit for controlling the at least one sensor. Specifically, the sensing unit 208 may include at least one of a gyro sensor, a magnetic sensor, an acceleration sensor, a grip sensor, a proximity sensor, a color sensor, a bio sensor, an air pressure sensor, a temperature sensor, a humidity sensor, an illuminance sensor, or an ultra violet (UV) sensor, an e-nose sensor, a gesture sensor, an electromyography (EMG) sensor, an electroencephalogram (EEG) sensor, an electrocardiogram (ECG) sensor, an infrared (IR) sensor, an iris sensor, or a fingerprint sensor.

The audio input/output unit 210 outputs sound according to electrical signals generated based on audio data and detects external sound. That is, the audio input/output unit 210 may convert sound and electrical signals into each other. To this end, the audio input/output unit 210 may include at least one of a speaker, a microphone, or a circuit for controlling them.

The camera module 212 collects data for generating images and videos. To this end, the camera module 212 may include at least one of a lens, a lens driving circuit, an image sensor, a flash, or an image processing circuit. The camera module 212 may collect light through the lens and generate data expressing color values and luminance values of light using the image sensor.

The memory 214 may store an operating system, programs, applications, commands, setting information and the like necessary to operate the client device. The memory 214 may temporarily or non-temporarily store data. The memory 214 may include a volatile memory, a non-volatile memory, or a combination of the volatile and non-volatile memory.

The power supply unit 216 supplies power necessary for the operation of components of the client device. To this end, the power supply unit 216 may include a converter circuit that converts power into power with a magnitude required by each component. The power supply unit 216 may depend on an external power source or may include a battery. In the case of including the battery, the power supply unit 216 may further include a circuit for charging. The circuit for charging may support wired charging or wireless charging.

The external connection terminal 218 is a physical connection unit for connecting the client device to another device. For example, the external connection terminal 218 may include at least one of terminals of various standards, such as a universal serial bus (USB) terminal, an audio terminal, a high definition multimedia interface (HDMI) terminal, a recommended standard-232 (RS-232) terminal, an infrared terminal, an optical terminal, or a power terminal.

The processor 220 controls the overall operation of the client device. The processor 220 may control operations of other components and perform various functions using other components. For example, the processor 220 may also request content data from the server through the communication unit 206 and receive the content data. Also, the processor 220 may restore content by decoding the received content data. Also, the processor 220 may output content received from the server through the display 202 and the audio input/output unit 210. In addition, the processor 220 may control a state related to reproduction of content based on information input or sensed by at least one of the input unit 204, the communication unit 206, the sensing unit 208, the audio input/output unit 210, the camera module 212, the power supply unit 216, and the external connection terminal 218. To this end, the processor 220 may include at least one of at least one processor, at least one microprocessor, or at least one digital signal processor (DSP). In particular, the processor 220 may control other components and perform necessary operations so that the client device operates according to various embodiments described below.

In the structure of the client device described with reference to FIG. 2, all components are illustrated as being connected to the processor 220. Although not shown in FIG. 2, at least some of the components may be connected through a bus. In this case, under the control of the processor 220, direct data exchange may be made between some components.

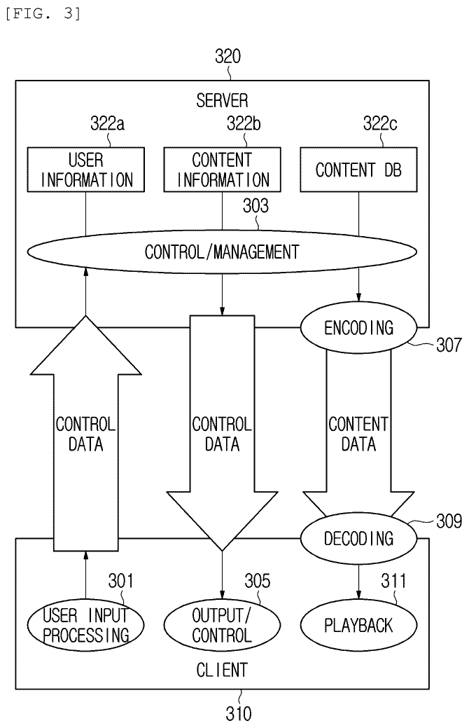

FIG. 3 illustrates a concept of a content streaming service according to an embodiment of the present disclosure. FIG. 3 is a schematic diagram of some functions related to content streaming, and a content streaming service according to various embodiments may have various other functions in addition to the functions illustrated in FIG. 3.

Referring to FIG. 3, control data and content data may be transmitted and received between the client 310 and the server 320. Specifically, transmission of control data from the client 310 to the server 320, transmission of control data from the server 320 to the client 310, and transmission of content data from the server 320 to the client 310 may be performed.

The server 320 stores user information 322a, content information 322b, and content database (DB) 322c. The user information 322a may include user account information, service use history information of users, information about user preferences, and the like. The content information 322b may include a list of serviceable content, content guide information, content meta information, and content consumption history information. The content DB 322c may include content stored in the form of data. In addition to this, the server 320 may further store other information required to provide services.

Control data transmitted from the client 310 to the server 320 may include information on user log-in, information on content selection by the user, information on control of content by the user, and the like. To this end, the client 310 may generate control data from user input through a user input processing operation 301 and transmit it. Control data from the client 310 is processed through a control/management operation 303 and used to provide content. For example, control data and/or content may be selected based on the control data from the client 301 by the control/management operation 303. In addition, preference may be determined by analyzing consumption history and behavior of the user by the control/management operation 303, and content to be recommended may be selected according to the determined preference.

A procedure for providing content to a user will be described with reference to FIG. 3 as follows. First, the client 310 generates control data including log-in information (e.g., ID and password) input by a user through the user input processing operation 301 and transmits the control data. The server 320 determines whether the user is valid by searching the user information 322a for log-in information included in the control data from the client 310, and determines the range of content and services allowed according to the user's authority. However, if log-in is not required or limited services that may be provided without log-in are supported, the transmission and processing of log-in information may be omitted.

Subsequently, the server 310 extracts content guide information from the content information 322b through the control/management operation 303 and transmits control data including the content guide information to the client 310. The client 310 outputs the content guide information included in the control data and confirms user's selection. The user's selection is transmitted to the server 310 as control data via the user input processing operation 301. Information about the user's selection is processed by the control/management operation 303 and used for selection of content to be streamed. The server 320 searches the content DB 322 for the selected content, compresses and segments the searched content through an encoding operation 307, and transmits content data. The content data may be compressed in advance through the encoding operation 307 and stored. Here, the encoding operation 307 may include not only an operation of compressing an original content image, but also an operation of decoding and then re-compressing content data generated through compression. In this case, compression may be performed based on the resolution, bitrate, and number of frames per second of the content image. When it is compressed and stored in advance, the compression operation is omitted, and the server 320 may perform segmentation on the content data. The content data may be restored through a decoding operation 309 and provided to a user through a playback operation 311. At this time, at least one of various video codecs or various audio codecs may be used for compression. For example, various video codecs include at least one of Moving Picture Experts Group-2 (MPEG-2), H.264 Advanced Video Coding (AVC), H.265 High Efficiency Video Coding (HEVC), H.266 Versatile video coding (VVC), VP8 (Video Processor 8), VP9 (Video Processor 9), AV1 (AOMedia Video 1), DivX, Xvid, VC-1, or Daala.

The audio codecs may include MP3 (MPEG 1 Audio Layer 3), AC3 (Dolby Digital AC-3), E-AC3 (Enhanced AC-3), AAC (Advanced Audio Coding, MPEG 2 Audio), FLAC (Free Lossless Audio Codec), HE-AAC (High Efficiency Advanced Audio Coding), OGG Vorbis, OPUS and the like.

A plurality of content data may be generated in advance by compressing a content image according to various resolutions, bitrates, and the number of frames per second of the image. The client 310 may measure throughput (or bandwidth) and determine a bitrate based on the measured throughput (or bandwidth).

The client 310 may receive information about a plurality of content data from the server 320. The received information may include information representing the bitrate, resolution, number of frames per second, and location of a plurality of content data.

The client 310 may determine at least one of content data based on the bitrate, and determine reproduced content data corresponding to the resolution and number of frames per second that may be reproduced among the at least one content data based on the capability information of the client 310, and its location. In this case, the capability information may include the maximum support resolution and the maximum number of supported frames of the client, but is not limited thereto.

The client 310 may transmit a content request to the server 320 based on the location of reproduced content data. The server 320 may transmit content data corresponding to the content request to the client 310 based on the received content request.

According to another embodiment, the client 310 may receive user input related to at least one of the resolution or number of frames per second of the image, determine the reproduced content data and its location according to the user input, and transmit the content request to the server 320.

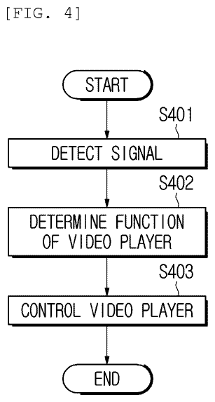

FIG. 4 is a flowchart of a manipulation method using a motion control mode according to an embodiment of the present disclosure. FIG. 4 illustrates a method of operating a device executing a video player (e.g., the client device 110 of FIG. 1).

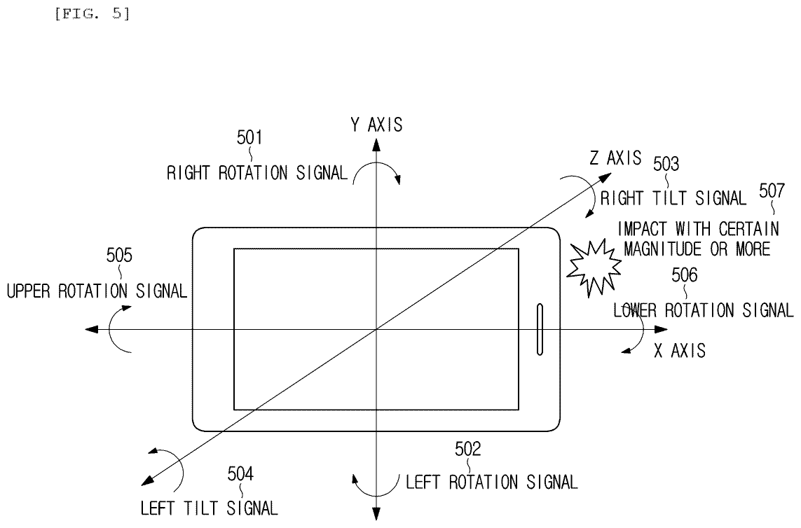

Referring to FIG. 4, in S401, the device may detect a signal. Specifically, the device may detect a motion signal. Here, the motion signal is a signal generated by a change in the physical posture of the device or application of physical force, and is generated by at least one sensor included in the device. For example, the motion signal is related to acceleration of three axes (e.g., X, Y, Z axes), azimuth (e.g., Yaw, Pitch, Roll), etc., and specifically, may include at least one of a tilt detection signal or an impact detection signal of the device. Also, the tilt detection signal of the device may include at least one of a right rotation signal, a left rotation signal, a right tilt signal, a left tilt signal, a lower rotation signal, or an upper rotation signal of the device. Details of the tilt detection signal will be described later with reference to FIG. 5. In the present disclosure, detection of the motion signal is an operation of recognizing motion by a signal generated by a sensor, and may be understood as the same meaning as ‘detection of motion’.

In S402, the device may determine the function of the video player. Specifically, the device may determine which function of the video player is to be adjusted and how to adjust the function in response to the signal detected in S401. That is, based on a mapping relationship between the functions of the video player for each detection signal predefined by the user, the device may determine which function of the video player is to be adjusted and how to adjust the function. Here, the function of the video player may include at least one of a volume control function (volume up/down), a brightness control function (brightness up/down), a playback/pause function, or a fast forward/rewind function, and the present disclosure is not limited thereto. According to an embodiment, the device may determine the function to be adjusted based on rotation represented by the detected signal (e.g., rotation about an axis of a specific tilt).

In S403, the device may control the video player. Specifically, the device may control the function of the video player determined in S402. For example, upon determining whether to increase or decrease the volume in S402, the device may control the volume (e.g., volume up or down) in response to the determination.

According to an embodiment, the device may determine the adjustment content (e.g., an item to be adjusted, a degree to be adjusted, etc.) based on the direction or degree of rotation or tilt expressed by the detected signal. For example, a unit of time moving forward when the degree of tilt is greater than a predetermined value (e.g., 10 seconds) may be greater than a unit of time moving forward when the degree of tilt is less than a predetermined value (e.g., 5 seconds).

In the process of controlling the function of the video player according to the above-described embodiment, the device may detect various movements of the device. Here, the movement of the device includes the tilt of the device. The tilt detection signal may be generated by a gyroscope. Here, the gyroscope is a sensor capable of detecting rotational motion. According to an embodiment of the present disclosure, the tilt detection signal generated by the gyroscope may include a right rotation signal, a left rotation signal, a right tilt signal, a left tilt signal, a lower rotation signal, or an upper rotation signal. Here, the right rotation signal may refer to a signal generated when the device rotates to the right around a central vertical line. In addition, the left rotation signal may refer to a signal generated when the device rotates to the left around the central vertical line (e.g., X axis or the Y axis). The right tilt signal may refer to a signal generated when the device rotates in a clockwise direction with respect to an axis (e.g., Z axis) crossing the center of the device from the front side to the rear side of the device. The left tilt signal may refer to a signal generated when the device rotates in a counterclockwise direction with respect to an axis (e.g., Z axis) crossing the center of the device from the front side to the rear side of the device. The lower rotation signal may refer to a signal generated when the device rotates in a lower direction around a central horizontal line (e.g., Y axis or an X axis) of the device. The upper rotation signal may refer to a signal generated when the device rotates in an upper direction around the central horizontal line.

An impact detection signal of the device according to an embodiment of the present disclosure may be generated by an acceleration sensor. Here, the acceleration sensor serves to measure dynamic forces such as acceleration, vibration, and impact of the device. Specifically, according to an embodiment of the present disclosure, when an impact is applied to the device, the acceleration sensor inside the device may detect a change in speed per unit time to generate an impact detection signal. Thereafter, the device may determine and control the function of the video player in response to the impact detection signal received from the acceleration sensor. That is, based on the function of the video player for each detection signal previously mapped by the user, the device may determine which function of the video player is adjusted, and control the function of the video player accordingly.

FIG. 5 illustrates functions of a video player corresponding to a motion operation according to an embodiment of the present disclosure.

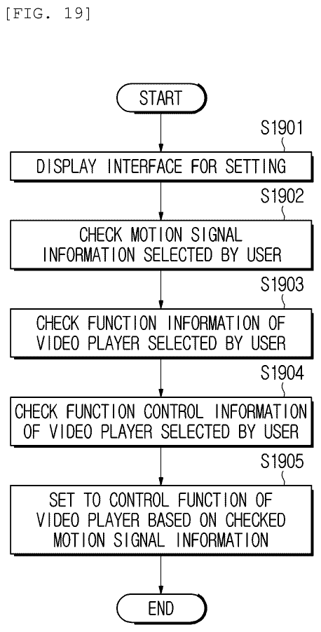

According to the present disclosure, a user may arbitrarily set a function of a video player corresponding to at least one of a tilt detection signal and an impact detection signal. For example, when a right rotation signal is detected, the user may set the device to increase the volume of the video player. As another example, when a right rotation signal is detected, the user may set the device to increase the brightness of the video player, but the present disclosure is not limited thereto. Referring to FIG. 5, the device may increase the volume of the video player when detecting the right rotation signal 501, and decrease the volume when detecting the left rotation signal 502. In addition, the device may fast-forward the video (e.g., move forward by 5 seconds) when detecting the right tilt signal 503, and rewind the video (e.g., move backward by 5 seconds) when detecting the left tilt signal 504. In addition, the device may brighten the brightness of the video (e.g., increase the brightness by 2%) when detecting the upper rotation signal 505, and darken the brightness of the video (e.g., decrease the brightness by 2%) when detecting the lower rotation signal 506. In addition, if an impact 507 with a certain magnitude or more is detected while the video is being played, the device may pause the video, and if an impact 507 with a certain magnitude or more is detected while the video is paused, the device may play the video again. Embodiments according to the present disclosure are not limited thereto, and the user may variously map functions of the video player corresponding to the tilt detection signal or the impact detection signal. Hereinafter, a detailed mapping method will be described in FIG. 19.

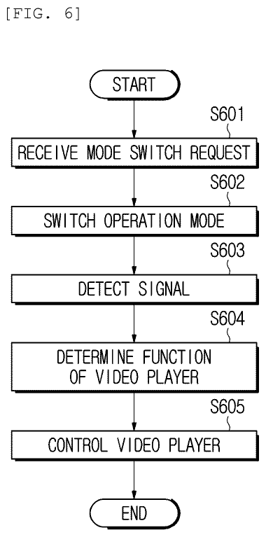

FIG. 6 illustrates a flowchart of a method of switching to a motion control mode according to an embodiment of the present disclosure. FIG. 6 illustrates a method of operating a device executing a video player (e.g., the client device 110 of FIG. 1).

Referring to FIG. 6, in S601, the device may receive a mode switch request. At this time, the mode switch request may be generated by a user's operation. Here, the mode switch request may be generated based on at least one of user's touch input, device shaking motion, time setting, or tilting motion of the device. The user's touch input, which is one of the mode switch requests, may be an operation (e.g., a long press operation) in which the user presses a user interface of the device for a predetermined period of time or longer, and the present disclosure is not limited thereto. In addition, the device shaking motion and the tilting motion of the device may be detected by a gyroscope or a tilt sensor, and a corresponding mode switch request signal may be generated. Also, the time setting may refer to a time designated arbitrarily according to a user request.

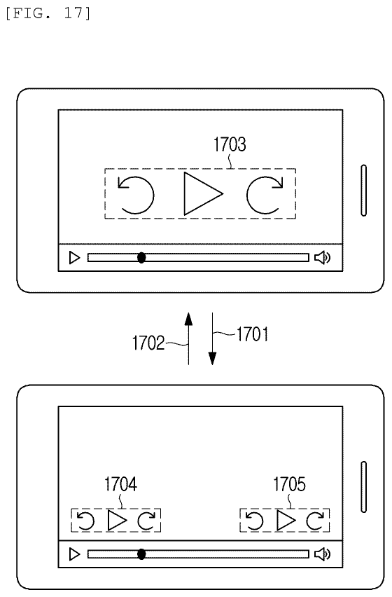

In S602, the device may switch the operation mode. Specifically, when the mode switch request is received in S601, the device may switch the operation mode accordingly. Here, the operation mode may be a motion control mode or a one-handed button mode. The motion control mode refers to a mode in which the function of the video player may be controlled according to the tilt detection signal or impact detection signal of the device. In addition, the one-handed button mode refers to a mode that provides a user interface whose location is changed so that a button may be pressed using one hand. A more specific one-handed button mode will be described later using FIG. 17.

In S603, the device whose operation mode is switched to the motion control mode may detect a signal. Specifically, the device may detect a motion signal. Here, the motion signal is a signal generated by a change in the physical posture of the device or the application of physical force, and is generated by a sensor included in the device. For example, the motion signal is related to acceleration, azimuth, and the like, and may specifically include at least one of a tilt detection signal or an impact detection signal of the device. Also, the tilt detection signal of the device may include at least one of a right rotation signal, a left rotation signal, a right tilt signal, a left tilt signal, a lower rotation signal, or an upper rotation signal of the device. In the present disclosure, detection of a motion signal is an operation of recognizing motion by a signal generated by a sensor, and may be understood as the same meaning as ‘detection of motion’.

In S604, the device may determine the function of the video player. Specifically, the device may determine which function of the video player is to be adjusted and how to adjust the function in response to the signal detected in S603. That is, the device may determine which function of the video player is to be adjusted and how to adjust the function, based on a mapping relationship between the functions of the video player for each detection signal predefined by the user. Here, the function of the video player may include at least one of a volume control function, a brightness control function, a playback/pause function, and a fast forward/rewind function, but the present disclosure is not limited thereto. According to an embodiment, the device may determine the function to be adjusted based on rotation represented by the detected signal (e.g., rotation about an axis of a specific tilt).

In S605, the device may control the video player. Specifically, the device may control the function after determining how to control the function of the video player determined in S604. For example, if it is determined whether to increase or decrease the volume in S604, the device may control the volume (e.g., volume up or down) in response to the determination.

According to an embodiment, the device may determine the adjustment content (e.g., an item to be adjusted, a degree to be adjusted, etc.) based on the direction or degree of rotation or tilt expressed by the detected signal. For example, a unit of time moving forward when the degree of tilt is greater than a predetermined value (e.g., 10 seconds) may be greater than a unit of time moving forward when the degree of tilt is less than a predetermined value (e.g., 5 seconds).

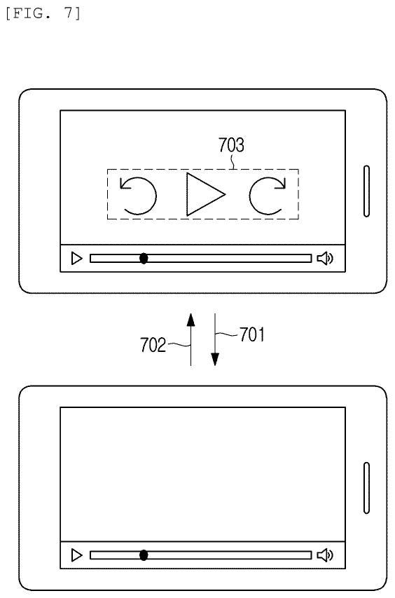

FIG. 7 illustrates an example of switching to a motion control mode corresponding to user's touch according to an embodiment of the present disclosure.

According to an embodiment of the present disclosure, the device may switch the operation mode by receiving a mode switch request of a user. Referring to FIG. 7, the device may switch to a motion control mode by user's touch input, which is one of the user's mode switch requests. Here, the user's touch input may be an input in which the user presses the interface of the device for a predetermined period of time (e.g., 2 seconds) or longer. For example, when the user presses one of the buttons (e.g., a rewind button, a play button, or a fast forward button) included in the video player operation interface 703 for a certain period of time or longer, the device may switch to the motion control mode (701). In addition, if one of the buttons included in a video player manipulation interface 703 (e.g., a rewind button, a play button, or a fast forward button) is pressed for a certain period of time or longer while the device is switched to the motion control mode, the device may return to the previous state mode (e.g., default control mode) (702). According to another embodiment of the present disclosure, when the user sends a mode switch request, a message asking for a mode switch intention may be displayed on the display of the device. In this case, when the device receives the mode switch request, the user may set whether to display a message asking for the user's intention.

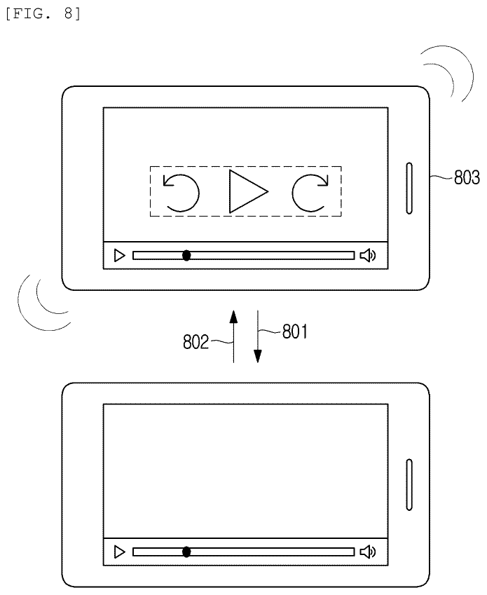

FIG. 8 illustrates an example of switching to a motion control mode corresponding to user's shaking motion of the device according to an embodiment of the present disclosure.

According to an embodiment of the present disclosure, the device may switch an operation mode by receiving a user's mode switch request. The device may be switched to the motion control mode by the device shaking operation, which is one of the user's mode switch requests. Here, the user's device motion operation may be detected by a gyroscope or a tilt sensor. Referring to FIG. 8, when a user shakes the device 803, the operation mode of the device may be switched to a motion control mode (801). Also, when the user shakes the device again in a state where the operation mode is switched to the motion control mode, the operation mode of the device may return to the previous mode (e.g., the default control mode) (802). Also, according to an embodiment of the present disclosure, the user may set the number of times of shaking the device for switching the operation mode to the motion control mode. By setting the number of times of shaking the device by the user, it is possible to reduce errors in the case of shaking the device naturally in daily life. According to another embodiment of the present disclosure, when the user sends a mode switch request, a message asking for a mode switch intention may be displayed on the display of the device. In this case, whether to display a message asking for the intention of switching to the motion control mode may be set by the user.

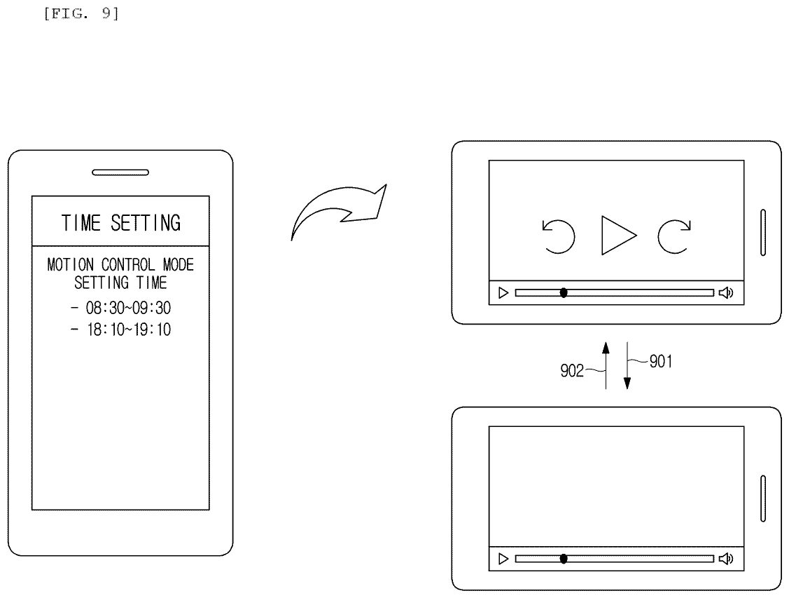

FIG. 9 illustrates an embodiment of switching to a motion control mode corresponding to time setting.

According to an embodiment of the present disclosure, the device may switch an operation mode by receiving a user's mode switch request. The device may be switched to the motion control mode by time setting, which is one of the user's mode switch requests. Specifically, it may be switched to the motion control mode at a time preset by the user. For example, when the user wants to switch to the motion control mode when commuting, the user may set a time so that the device switches to the motion control mode at the corresponding time. Accordingly, when the time set by the user is reached, the device may automatically switch the operation mode to the motion control mode (901). In addition, after the time set by the user, the device may automatically return to the previous mode (e.g., the default control mode) (902). According to another embodiment of the present disclosure, when the time set by the user is reached, a message asking for a mode switch intention may be displayed on the display of the device. At this time, the user may set whether to display a message asking for an intention of switching to the motion control mode. In addition, after the time set by the user, the device may display a message asking whether to return to the default control mode on the display.

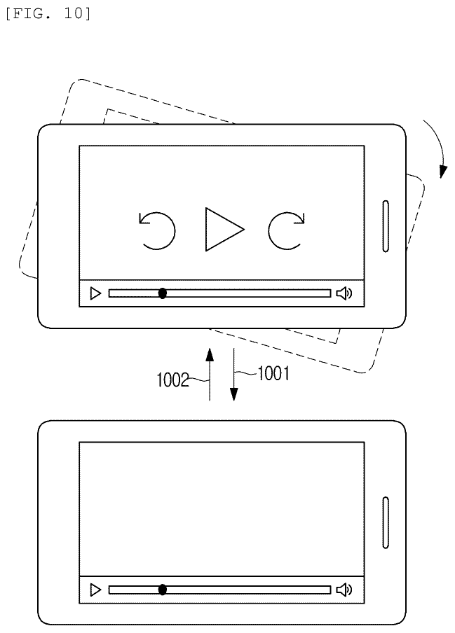

FIG. 10 illustrates an embodiment of switching to a motion control mode corresponding to a tilt of a device.

According to an embodiment of the present disclosure, the device may switch the operation mode by receiving a user's mode switch request. The device may switch the operation mode to the motion control mode by the tilt of the device, which is one of the user's mode switch requests. Referring to FIG. 10, when the user tilts the device in a specific direction, a gyroscope inside the device may detect this. When the gyroscope detects rotation of the device, a tilt signal of the device may be generated by the gyroscope. Accordingly, after receiving the tilt signal, the device may switch the operation mode to the motion control mode (1001). At this time, the tilting direction of the device may be arbitrarily set by the user. For example, when the user rotates the device in a right tilt rotation direction, the operation mode may be set to be switched to a motion control mode, but embodiments of the present disclosure are not limited thereto. Also, when the user tilts the device in a specific direction in a state of switching to the motion control mode, the device may return to the previous mode (e.g., the default control mode) (1002). Even in this case, the user may arbitrarily set the tilting direction of the device for returning to the default control mode. For example, the tilting direction may be opposite to the tilting direction for switching to the motion control mode.

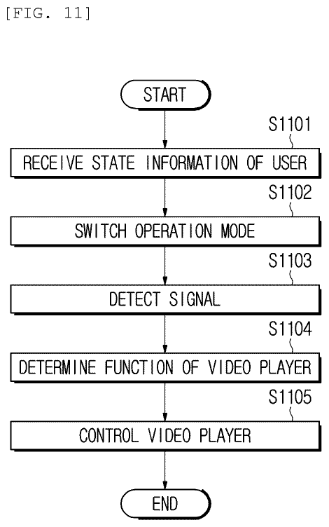

FIG. 11 illustrates a flowchart of a method of switching to a motion control mode according to an embodiment of the present disclosure. FIG. 11 illustrates a method of operating a device executing a video player (e.g., the client device 110 of FIG. 1).

Referring to FIG. 11, in S1101, the device may receive state information of a user. Here, the state information of the user may include information on at least one of the location of the user, the motion state of the user, and the means of movement of the user. The information on the location of the user, which is one of the user state information, may be determined by a Global Positioning System (GPS) signal or an identifier of an access point (AP) of a wireless network. Also, the information on the motion state of the user may be determined by the user's heart rate signal, GPS signal, and the like. Also, the information on the means of movement of the user may be determined by a GPS signal.

In S1102, the device may switch the operation mode. Specifically, when the user state information is received in S1101, the device may switch the operation mode accordingly. Here, the switched operation mode may be a motion control mode or a one-handed button mode. The motion control mode refers to a mode in which the function of the video player may be controlled according to the tilt detection signal or impact detection signal of the device. In addition, the one-handed button mode refers to a mode that provides a user interface whose location is changed so that a button may be pressed using one hand. A more specific one-handed button mode will be described later using FIG. 17.

In S1103, the device whose operation mode is switched to the motion control mode may detect a signal. Specifically, the device may detect a motion signal. Here, the motion signal is a signal generated by a change in the physical posture of the device or the application of physical force, and is generated by a sensor included in the device. For example, the motion signal is related to acceleration, azimuth, and the like, and may specifically include at least one of a tilt detection signal or an impact detection signal of the device. Also, the tilt detection signal of the device may include at least one of a right rotation signal, a left rotation signal, a right tilt signal, a left tilt signal, a lower rotation signal, or an upper rotation signal of the device. In the present disclosure, detection of a motion signal is an operation of recognizing motion by a signal generated by a sensor, and may be understood as the same meaning as ‘detection of motion’.

In S1104, the device may determine the function of the video player. Specifically, the device may determine which function of the video player is to be adjusted and how to adjust the function in response to the signal detected in S1103. That is, the device may determine which function of the video player is to be adjusted and how to adjust the function, based on a mapping relationship between the functions of the video player for each detection signal predefined by the user. Here, the function of the video player may include at least one of a volume control function, a brightness control function, a playback/pause function, and a fast forward/rewind function, but the present disclosure is not limited thereto. According to an embodiment, the device may determine the function to be adjusted based on rotation represented by the detected signal (e.g., rotation about an axis of a specific tilt).

In S1105, the device may control the video player. Specifically, the device may control the function after determining how to control the function of the video player determined in S1104. For example, if it is determined whether to increase or decrease the volume in S1104, the device may control the volume (e.g., volume up or down) in response to the determination.

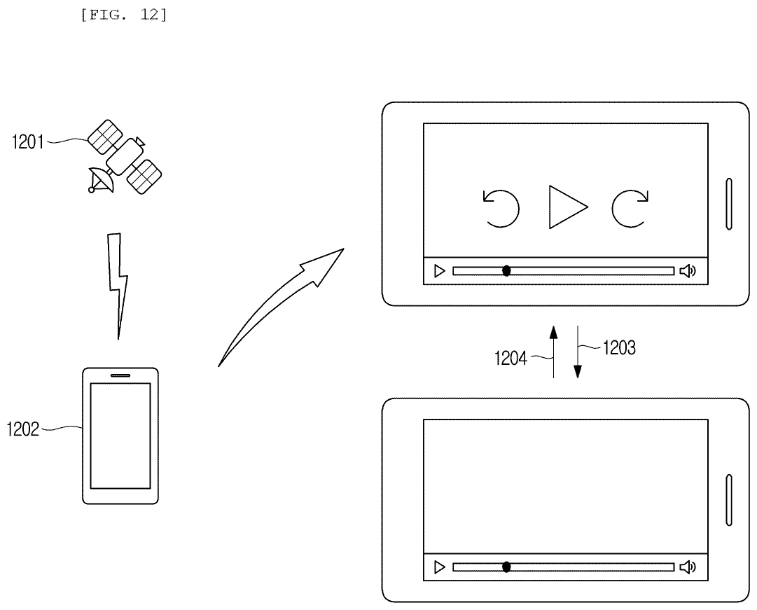

FIG. 12 illustrates an example of switching to a motion control mode using a GPS signal according to an embodiment of the present disclosure.

According to an embodiment of the present disclosure, when the user is in a specific location range, the device 1202 may automatically switch the operation mode to the motion control mode (1203). Also, when the user moves out of the specific location range, the device 1202 may automatically return the operation mode to a previous mode (e.g., a default control mode) (1204). According to another embodiment of the present disclosure, when the user moves out of the specific location range, the device 1202 may automatically switch the operation mode to the motion control mode (1203). At this time, the specific location range may be arbitrarily designated by the user. According to another embodiment of the present disclosure, when the device 1202 is within a specific location range, a message asking for a mode switch intention may be displayed on the display of the device 1202. In this case, the user may set whether to display a message asking for the intention of switching to the motion control mode. The location of the user may be determined by a GPS signal. Specifically, referring to FIG. 12, the device 1202 may obtain location information of the device 1202 by receiving a signal transmitted from a GPS satellite 1201, and determine whether the operation mode is switched to the motion control mode using the obtained location information.

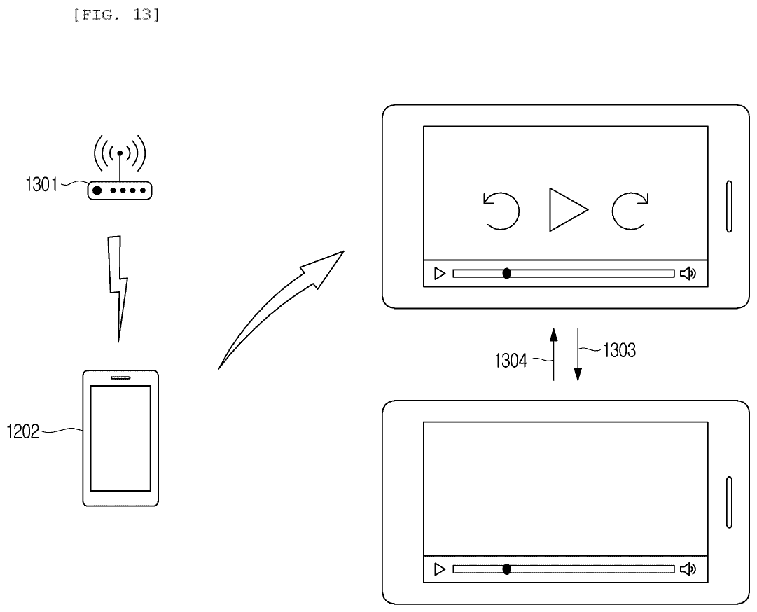

FIG. 13 illustrates an example of switching to a motion control mode corresponding to a WIFI AP of a user according to an embodiment of the present disclosure.

According to an embodiment of the present disclosure, when a user is connected to a specific WIFI AP 1301, the device 1202 may automatically switch an operation mode to a motion control mode (1303). In addition, when the user is disconnected from the specific WIFI AP 1301, the device 1202 may automatically return the operation mode to the previous mode (e.g., default control mode) (1304). According to another embodiment of the present disclosure, when the user is disconnected from the specific WIFI AP 1301, the device 1202 may automatically switch the operation mode to the motion control mode (1303). According to another embodiment of the present disclosure, when the device 1202 is connected to the specific WIFI AP 1301, the device 1202 may display a message asking for the intention of switching the mode on the display. At this time, the user may set whether to display a message asking for the intention of switching to the motion control mode.

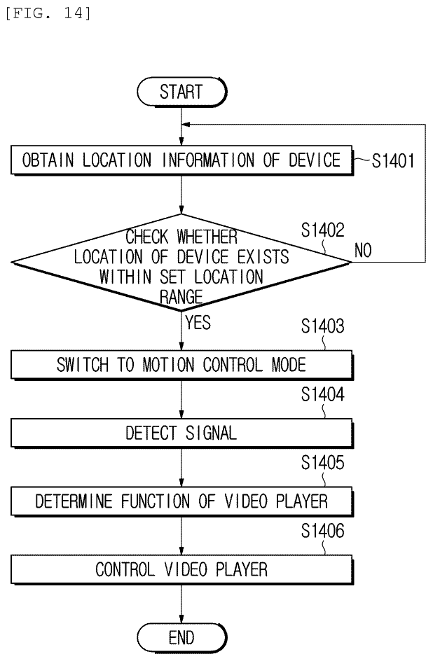

FIG. 14 is a flowchart illustrating switching to a motion control mode corresponding to a location of a user according to an embodiment of the present disclosure. FIG. 14 illustrates a method of operating a device executing a video player (e.g., the client device 110 of FIG. 1).

Referring to FIG. 14, in S1401, the device (e.g., the client device 110 in FIG. 1) may obtain location information of the device. For example, the device may obtain location information of the device by receiving a signal transmitted from a GPS satellite at the device. As another example, when the device is connected to a specific WIFI AP, the device may receive location information of the corresponding WIFI AP.

In S1402, the device may check whether the location of the user exists within a set location range. If the location of the user exists within the set location range, S1403 may be performed. That is, the device may switch the operation mode to the motion control mode. At this time, the range of location that are switched to the motion control mode may be arbitrarily set by the user.

In S1404, the device whose operation mode is switched to the motion control mode may detect a signal. Specifically, the device may detect a motion signal. Here, the motion signal is a signal generated by a change in the physical posture of the device or the application of physical force, and is generated by a sensor included in the device. For example, the motion signal is related to acceleration, azimuth, and the like, and may specifically include at least one of a tilt detection signal or an impact detection signal of the device. Also, the tilt detection signal of the device may include at least one of a right rotation signal, a left rotation signal, a right tilt signal, a left tilt signal, a lower rotation signal, or an upper rotation signal of the device. In the present disclosure, detection of a motion signal is an operation of recognizing motion by a signal generated by a sensor, and may be understood as the same meaning as ‘detection of motion’.

In S1405, the device may determine the function of the video player. Specifically, the device may determine which function of the video player is to be adjusted and how to adjust the function in response to the signal detected in S1404. That is, the device may determine which function of the video player is to be adjusted and how to adjust the function, based on a mapping relationship between the functions of the video player for each detection signal predefined by the user. Here, the function of the video player may include at least one of a volume control function, a brightness control function, a playback/pause function, and a fast forward/rewind function, but the present disclosure is not limited thereto. According to an embodiment, the device may determine the function to be adjusted based on rotation represented by the detected signal (e.g., rotation about an axis of a specific tilt).

In S1406, the device may control the video player. Specifically, the device may control the function after determining how to control the function of the video player determined in S1405.

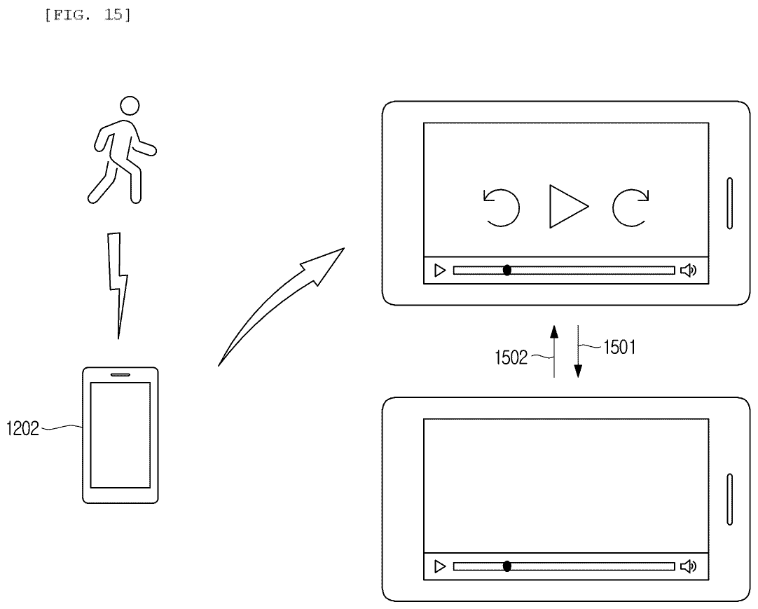

FIG. 15 illustrates an embodiment of switching to a motion control mode corresponding to an motion state of a user according to an embodiment of the present disclosure.

According to an embodiment of the present disclosure, according to the motion state of the user, the device 1202 may automatically switch the operation mode to a motion control mode (1501). Specifically, the device 1202 may use an acceleration sensor to determine that the user is walking. Accordingly, upon determining that the user is walking, the device 1202 may automatically switch the operation mode to the motion control mode (1501). In addition, upon determining that the user is in a stopped state or sitting state, the device 1202 may return the operation mode to a default mode (1502). According to another embodiment of the present disclosure, the device 1202 may determine the motion state of the user through a step counting function (a step measurement function) based on the acceleration sensor. In this case, upon determining that the user is walking, the device 1202 may automatically switch the operation mode to the motion control mode (1501), and upon determining that the user is in a stopped or sitting state, the device 1202 may return the operation mode to the default control mode (1502). According to another embodiment of the present disclosure, it may be determined that the user is walking using a GPS signal, but the present disclosure is not limited thereto.

According to another embodiment of the present disclosure, upon determining that the user is walking, the device 1202 may display a message asking for a mode switch intention on the display. At this time, the user may set whether to display the message asking for the mode switch intention.

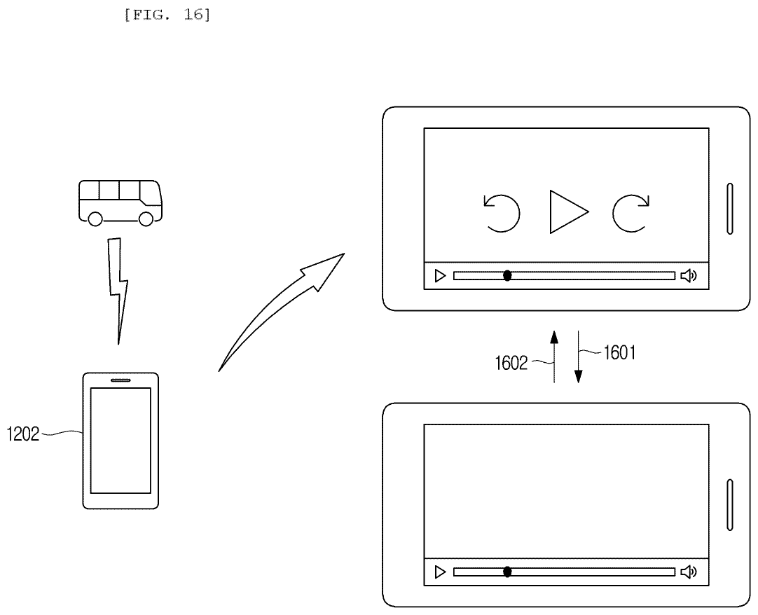

FIG. 16 illustrates an embodiment of switching to a motion control mode corresponding to a means of movement of a user according to an embodiment of the present disclosure.

According to an embodiment of the present disclosure, according to the current means of movement of the user, the device 1202 may automatically switch the operation mode to the motion control mode (1601). Specifically, the device 1202 may determine the means of movement of the user using an acceleration sensor or a GPS signal. Additionally, the device 1202 may determine the means of movement of the user based on a change in GPS signal over time. In addition, the device 1202 may receive a signal transmitted from a beacon installed in the means of transportation and determine the means of movement of the user.

For example, upon determining that the user is using a means of transportation such as a subway or a bus, the device 1202 may automatically switch the operation mode to the motion control mode (1601). Also, upon determining that the user is in a stopped state, the device 1202 may automatically return the operation mode to the default control mode (1602). According to another embodiment of the present disclosure, upon determining that the user is using the means of transportation, the device 1202 may display a message asking for a mode switch intention on the display. In addition, upon determining that the user is in a stopped state, the device 1202 may display a message asking for an intention of returning to the default control mode on the display. At this time, the user may set whether to display the message asking for the mode switch intention.

FIG. 17 illustrates an embodiment of switching to a one-handed button mode according to an embodiment of the present disclosure.

According to an embodiment of the present disclosure, the operation mode for the video player of the device may include a default control mode, a motion control mode, and/or a one-handed button mode. Here, the default control mode is a mode for providing a default interface of the video player, and may mean a mode for controlling the function of the video player through the default interface. The one-handed button mode may refer to a mode that provides a user interface whose location is changed so that a button may be pressed using one hand. Referring to FIG. 17, when the user presses the rewind button or fast forward button of a video manipulation interface 1703 of the video player for a predetermined period of time or longer, the operation mode may be switched to the one-handed button mode (1701). For example, when the user presses the rewind button for a predetermined period of time or longer, a video manipulation interface 1704 may be located at the bottom left end of the display of the device. In addition, when the user presses the fast forward button for a predetermined period of time or longer, a video manipulation interface 1705 may be located at the bottom right end of the display of the device. The video manipulation interface 1704 is not limited to being located at the bottom left end, and may be located adjacent to the left corner (e.g., the left center or the top left end) so that the user may touch it using the left hand according to another embodiment of the present disclosure. Similarly, the video manipulation interface 1704 may be located adjacent to the right corner (e.g., the right center or top right end).

In addition, when at least one button of the video manipulation interfaces 1704 and 1705 is pressed for a certain period of time or longer while the device is switched to the one-handed button mode, the device may return to the previous mode (e.g., default control mode) (1702).

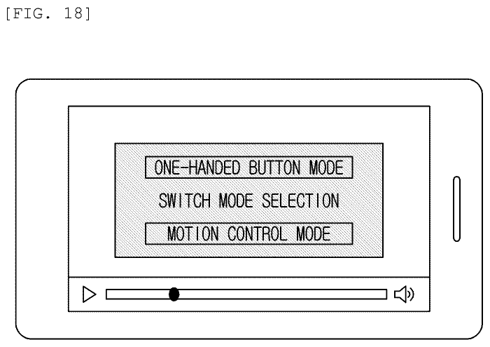

FIG. 18 illustrates a mode switch selection message according to an embodiment of the present disclosure.

According to an embodiment of the present disclosure, when a user presses a rewind button or a fast forward button of the video manipulation interface for a predetermined period of time or longer, the device may display a message for selecting which mode it is switched to on the display. In this case, the user may switch the operation mode to the desired mode by selecting the desired mode from the message. According to another embodiment of the present disclosure, the operation mode is switched to the one-handed button mode when the video manipulation button is pressed for a predetermined period of time or longer according to user setting, and the operation mode is switched to the motion control mode by the device shaking device or device tilting. That is, the user may arbitrarily set the mode switch request operation of the user and which operation mode it is switched to according to the operation, but the present disclosure is not limited thereto.

According to an embodiment of the present disclosure, the user may variously map functions of the video player corresponding to motion signals. Here, the motion signal may be a tilt detection signal or an impact detection signal. To this end, the device may provide a function for setting a mapping relationship between a motion signal and function control of the video player according to a user's command. A procedure for setting the mapping relationship between the motion signal and function control of the video player is as follows.

FIG. 19 is a flowchart of a function mapping method of a video player corresponding to a motion signal according to an embodiment of the present disclosure. FIG. 19 illustrates a method of operating a device executing the video player (e.g., the client device 110 of FIG. 1).

In S1901, the device may display an interface for setting. Specifically, the device may display an interface for setting a mapping relationship so that the user may define a mapping relationship between video player functions for each detected signal. At this time, the display of the interface for setting may be performed at the user request. Here, the user request may include clicking on a setting screen on the display of the device or a user request by voice recognition, and the present disclosure is not limited thereto. In the present disclosure, the interface for setting may be understood as the same meaning as a ‘setting screen’.

In S1902, the device may check motion signal information selected by the user. Specifically, the user may select a motion signal to be used in the motion control mode through the interface displayed in S1901. Accordingly, the device may check information on the motion signal selected by the user. That is, when the user selects to which motion signal the function of the video player is mapped on the setting screen of the device, the device may check which motion signal the user has selected. Here, the motion signal is a signal generated by a change in the physical posture of the device or application of physical force, and may be generated by a sensor included in the device. For example, the motion signal is related to acceleration, azimuth, etc., and may specifically include at least one of a right rotation signal, a left rotation signal, a right tilt signal, a left tilt signal, a lower rotation signal, an upper rotation signal, or an impact signal of the device.

In S1903, the device may check function information of the video player selected by the user. Specifically, the user may select a function of the video player function to be controlled in response to the motion signal selected in S1902. That is, when the user selects the function of the video player on the setting screen of the device, the device may check the function of the video player selected by the user. Accordingly, the device may check the function information of the video player selected by the user together with the motion signal information checked in S1902. Here, the function of the video player may include at least one of a volume control function, a brightness control function, a playback/pause function, and a fast forward/rewind function.

In S1904, the device may check function control information of the video player selected by the user. Specifically, the user may select how to adjust the function of the video player selected in S1903. That is, when the user selects how to control the function of the video player on the setting screen of the device, the device may check function control information of the video player selected by the user. Accordingly, the device may check function control information of the video player selected by the user together with the information checked in steps S1902 and S1903.

In S1905, the device may set to control the function of the video player based on the checked motion signal information. That is, the device may set which function is controlled and how to control the function in response to which signal using each of information checked in steps S1902, S1903, and S1904. For example, if the user selects the right rotation signal of the device in S1902, selects the volume control function in S1903, and selects control to increase the volume in S1904, the device may set to increase the volume when the right rotation signal is detected. The present disclosure is not limited thereto, and may be mapped in various combinations by the user.

According to an embodiment of the present disclosure, a motion signal sensitivity test and a weight correction procedure may be performed. In some cases, the function of the video player mapped by the user may not be performed accurately. In this case, in order to more accurately perform the function, the device may test the motion signal sensitivity and modify the weight in the process of mapping the function of the video player. More specifically, after S1904, the device may perform a step of testing motion signal sensitivity and modifying a weight. Here, the motion signal sensitivity may mean accuracy and/or sensitivity of video player control corresponding to the motion signal. The step of testing motion signal sensitivity may be a step of checking whether a video player function corresponding to an operation motion signal mapped by the user is accurately performed. For example, when the user sets the volume to increase in response to a right rotation signal, the device may provide a test interface so that the user may perform a right rotation operation. Accordingly, the device may check whether the volume is increased when the user performs the right rotation operation. Also, the device may perform a weight correction step based on the test step. More specifically, when it is recognized that an error has occurred in the motion signal by the user as a result of performing the test step, the device may adjust the error by correcting the weight. Here, the weight may be a value given to the motion signal according to a tilt (or rotation) direction and/or a tilt degree (tilt) along the tilt axis. For example, the weight may be set in response to a right rotation motion and a specific tilt, but may be corrected in response to a tilt smaller than the specific tilt. That is, as the weight is corrected, the video player may be controlled even with a small tilt. Alternatively, if a reference rotation direction (e.g., right rotation direction) is different from the rotation direction (upper right rotation direction) of the motion operation actually performed by the user, the weight for the upper rotation direction is corrected or the weight for the right rotation direction is corrected, controlling the video player in response to the motion actually performed by the user. Here, the error may be a tilt difference value between a motion operation signal as a reference and a motion operation actually performed by a user and/or a difference of a tilt axis (or a rotation direction according to a tilt axis), but the present disclosure is not limited thereto.

According to an embodiment of the present disclosure, the function of the video player corresponding to the motion operation may be updated. That is, if the function of the video player controlled in response to a specific motion operation is different from what the user desires, the device may update the function of the video player corresponding to the motion operation by recognizing this. A procedure for updating a mapping relationship between the motion operation and function control of the video player may be as follows.

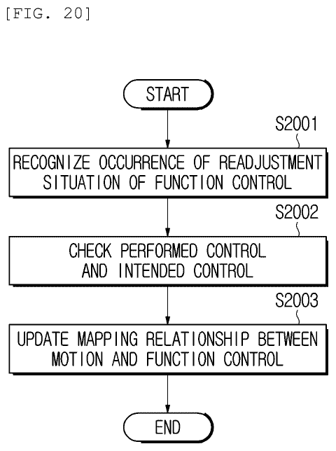

FIG. 20 illustrates a flowchart of a function control readjustment method according to an embodiment of the present disclosure. FIG. 20 illustrates a method of operating a device executing a video player (e.g., the client device 110 of FIG. 1).

Referring to FIG. 20, in S2001, the device may recognize the occurrence of a readjustment situation of function control. Here, the readjustment situation of function control may refer to a situation in which a function other than a function intended by the user is controlled and thus the user cancels the controlled function and controls a desired function again. That is, the function of the video player is controlled in response to the motion signal detected by the device, but the user cancels the function of the video player controlled within a certain period of time (hereinafter, a first threshold) and directly controls another function of the video player within a certain period of time (hereinafter, a second threshold), the device may recognize that a readjustment situation of function control has occurred. If such a readjustment situation of function control repeatedly occurs, the AI model may recognize the need to update the mapping relationship between motion and function control. A more specific method of recognizing the occurrence of a readjustment situation of function control will be described later.

In S2002, the device may check the performed control and the intended control. Specifically, the device may check what control is actually performed by the device. In addition, it is possible to check the control intended by the user. Here, the control intended by the user may be checked through the readjustment situation of the function control checked in S2001. More specifically, when the user cancels the function of the video player actually controlled by the device and directly controls another function of the video player within a certain period of time, the user's intended control may be checked by checking the directly controlled function. Here, canceling the function actually controlled by the device may mean that the user controls the function to return to a state immediately before the function of the video player is actually controlled by the device.

In S2003, the device may update a mapping relationship between the motion signal and function control. Specifically, after checking the control performed in S2002 and the intended control, the device may update the function control of the video player mapped to the motion signal performed by the user to the intended control. For example, if the user sets the video player function corresponding to the right rotation signal to volume control, but the device adjusts the brightness due to the user's device manipulation habit, the device will recognize this as a readjustment situation of the video player function control. At this time, the device may check the brightness control function, which is control performed actually, and the volume control function, which is control intended by the user. Then, the device may update the mapping relationship between the corresponding motion and function control. Accordingly, the present disclosure may increase the accuracy of the motion control mode.

In the embodiment described with reference to FIG. 20, the device may update the mapping relationship between the motion signal and function control in response to the readjustment situation of the function control. However, it may be against the user's intention to immediately update the mapping relationship between the motion signal and function control according to the occurrence of the situation. Therefore, according to another embodiment of the present disclosure, the device may perform a procedure for asking for the user's intention before updating the mapping relationship between the motion signal and function control. That is, the device may check the user's intention by displaying a message asking for the user's intention on the screen. Accordingly, the device may update the mapping relationship only when the user desires to update the mapping relationship.

In the embodiment described with reference to FIG. 20, a method for the device to recognize the occurrence of a readjustment situation of function control is as follows. First, after controlling the function of the video player corresponding to the motion signal, the device may check whether or not the user cancels the function within a predetermined time. In this case, the device may set a first threshold value for a predetermined time. Here, the first threshold may be a time taken from the function control of the video player by the device to cancellation of the function by the user. For example, when the user cancels a function within a first threshold set by the device, the device may perform a procedure for determining whether readjustment of function control is required. The procedure for checking whether readjustment of function control is required is a procedure for checking whether another function is directly controlled within a certain period of time after the function is canceled by the user. In this case, the device may set a second threshold for a certain period of time. Here, the second threshold may be a time required for the user to directly control the function after canceling the function by the user. For example, when the user directly controls the function within the second threshold set by the device, the device may recognize that the readjustment situation of function control has occurred. If such a readjustment situation of function control repeatedly occurs, the AI model may recognize the need to update the mapping relationship between motion and function control. Accordingly, the device may check the control performed by the device and the control intended by the user, and update the mapping relationship between motion and function control.

According to another embodiment of the present disclosure, when the function of the video player corresponding to the motion operation is not mapped, the device may suggest the function of the video player corresponding to a specific motion operation using the learned AI model. More specifically, the device may recognize a situation in which the user performs a specific motion operation to which a function is not mapped and directly adjusts the function of the video player function within a certain period of time. If this situation occurs repeatedly, the device may suggest mapping of the function of the video player adjusted by the user in response to the corresponding motion operation. In this case, the device may display information suggesting the mapping relationship on the display of the device.

According to another embodiment of the present disclosure, if a user repeatedly adjusts the same function of the video player at a specific location, the device may recognize this and then map the function of the video player adjusted by the user in response to the corresponding location. According to another embodiment of the present disclosure, if the user repeatedly adjusts the same function of the video player at a specific time, the device may recognize this and then map the function of the video player adjusted by the user in response to the corresponding time.

The exemplary methods of the present disclosure are represented in a series of operations for clarity of description, but this is not intended to limit the order in which the steps are performed, and each step may be performed simultaneously or in a different order, if necessary. In order to realize a method according to the present disclosure, the steps illustrated may include further other steps, or may include the remaining steps with the exception of some steps, or may include additional other steps with the exception of some steps.

Various embodiments of the present disclosure are not intended to enumerate all possible combinations, but to describe a representative aspect of the present disclosure, and the matters described in the various embodiments may be applied independently or in combination of two or more.

In addition, various embodiments of the present disclosure may be realized by hardware, firmware, software, or a combination thereof. In the case of hardware realization, the embodiments may be realized by one or more ASICs (Application Specific Integrated Circuits), DSPs (Digital Signal Processors), DSPDs (Digital Signal Processing Digital Signal Processing Devices (DSPs), Programmable Logic Devices (PLDs), Field Programmable Gate Arrays (FPGAs), general processors, controllers, microcontrollers, microprocessors, etc.

The scope of the present disclosure includes software or machine-executable commands (e.g., operating systems, applications, firmware, programs, etc.) that allow an operation according to a method of various embodiments to be performed on a device or computer, and a non-transitory computer-readable medium in which such software or commands are stored and executed on the device or computer.

1. A method of controlling a video player according to a motion control mode, the method comprising:
detecting at least one of a tilt detection signal or an impact detection signal of a device;
determining a function of the video player in response to the detected signal; and
controlling the video player in response to the determined function of the video player,
wherein the function of the video player comprises at least one of a volume control function, a brightness control function, a playback/pause function or a fast forward/rewind function.

2. The method of claim 1, further comprising:
detecting a mode switch request of a user; and
switching an operation mode of the video player to the motion control mode in response to the mode switch request of the user.

3. The method of claim 2, wherein the mode switch request of the user corresponds to at least one of touch input, device shaking operation or time setting of the user.

4. The method of claim 3, wherein the touch input of the user is a touch input for a certain period of time or longer to a rewind item or a fast forward item among video manipulation items included in a user interface of the video player.

5. The method of claim 1, wherein the tilt detection signal comprises at least one of a right rotation signal, a left rotation signal, a right tilt signal, a left tilt signal, a lower rotation signal or an upper rotation signal of the device.

6. The method of claim 5, wherein the function of the video player corresponding to at least one of the tilt detection signal or the impact detection signal is set by a user.

7. The method of claim 1, further comprising:
receiving state information of a user; and
switching an operation mode of the video player to the motion control mode in response to the state information of the user.

8. The method of claim 7, wherein the state information of the user comprises information on at least one of a location of the user, an motion state of the user or a means of movement of the user.

9. The method of claim 8, wherein the information on the location of the user is determined by an identifier of an access point of a wireless network or a global positioning system (GPS) signal.

10. The method of claim 8, wherein the information on the motion state of the user or the means of movement of the user is detected by at least one of a gyroscope, an acceleration sensor or a GPS sensor inside the device.

11. The method of claim 1, further comprising:
recognizing occurrence of a readjustment situation of function control;
checking control actually performed by the device and control intended by a user; and
updating a mapping relationship between a motion signal and function control.

12. A device for controlling a video player according to a motion control mode, the device comprising:
a memory configured to store information necessary for operation of the device; and
a processor connected to the memory,
wherein the processor is configured to:
detect at least one of a tilt detection signal or an impact detection signal of the device;
determine a function of the video player in response to the detected signal; and
control the video player in response to the determined function of the video player,
wherein the function of the video player comprises at least one of a volume control function, a brightness control function, a playback/pause function or a fast forward/rewind function.
